(19) United States
(12) Patent Application Publication
(10) Pub. No.: US 2013/0044939 A1
(43) Pub. Date: Feb. 21, 2013

(54) Method and system for modifying binocular images

(71) Applicant: Zhaoping Li, London (GB)

(72) Inventor: Zhaoping Li, London (GB)

(73) Assignee: UCL BUSINESS PLC, London (GB)

(21) Appl. No.: 13/137,468

(22) Filed: Aug. 18, 2011

(51) Int. Cl. G06K 9/00

(52) U.S. Cl. 382/154

(57) ABSTRACT

The present invention relates to a method for modifying binocular images, for example, to manipulate the attention of viewers. The binocular images may be for 2D or 3D scenes. The method modifies a left image destined for a left eye and a right image destined for a right eye, by modifying a portion of the left image by adjusting a visual characteristic of the portion in a first direction by a first defined value and modifying a corresponding portion of the right image by adjusting the visual characteristic of the corresponding portion in the opposite of the first direction by a second defined value. A system with an image modification means for modifying binocular images, an apparatus for displaying modified binocular images, a signal and medium for carrying/storing modified binocular images, and a computer program for modifying binocular images are also disclosed.

### FIELD OF INVENTION

The present invention is in the field of image modification. In particular, but not exclusively, the present invention relates to a method and system for modifying binocular images to manipulate the attention of a viewer.

### BACKGROUND

Human beings are almost blind to objects a few degrees away in visual angle from their centre of gaze. This can be illustrated by the near impossibility to recognize a word 10 to 20 character spaces away from a word you are focusing on in this document, at a reading distance of 30-40 cm.

We normally shift gazes about 3 times per second to develop a good visual awareness of our environment. And when we look at the wrong places at the wrong time, or shift our gaze too slowly, it can be difficult, for example, to follow a story in a movie or follow instructions and clues in a learning/unfamiliar environment.

Existing techniques for directing viewers' attention include controlling the focus of a camera lens to place the area within the depth of field in focus and the remainder of the scene out of focus. One problem with this technique is that it requires forethought during capture of the image.

Other techniques for directing viewers' attention include generating a visual event, such as a flash. One problem with this technique is that the viewer is aware of the manipulation and it involves substantial perceptual modification of the image/video.

Therefore, there exists a need for an improved system to manipulate the attention or gaze of viewers towards particular objects within images. It may also be desirable to limit the awareness of viewers to this manipulation and limit the changes in the perception of the viewers.

It is an object of the present invention to provide a system for modifying binocular images that meets this need, or at least provides a useful alternative.

### SUMMARY OF INVENTION

According to a first aspect of the invention there is provided a method of modifying a left image destined for a left eye and a right image destined for a right eye, including:

i) modifying a portion of the left image by adjusting a visual characteristic of the portion in a first direction by a first defined value; and
ii) modifying a corresponding portion of the right image by adjusting the visual characteristic of the corresponding portion in the opposite of the first direction by a second defined value.

Preferably the first and second defined values are similar in magnitude. The values may differ by less than a defined threshold. This may result in a lower awareness of the manipulation by the viewer.

The visual characteristic may be one of, or a combination of: contrast, luminance, or colour.

The portions of the left and right images may relate to the same feature. For example, the portions of the left and right image may relate to the same visual object within a 3D scene. In one alternative, the portions of the left and right image may relate to an entire image except a specific feature (such as a visual object within a 3D scene).

The images may be modified by a processing unit within a television, such as a 3D television; an optical disc player, such as a 3D blu-ray player; a 3D camera; by active or passive filters placed within viewer's glasses or over camera lenses; by graphics or film editing software or hardware; by 2D to 3D conversion software or hardware; or any other image modification means.

The left and right images may evoke a perception of a 3D or 2D scene when viewed dichoptically.

In one embodiment, only one portion of the left image and a corresponding portion of the right image are modified. This may attract the viewer's attention to a single location within the images or the corresponding 3D scene.

In one embodiment, the steps of the method of the first aspect are repeated for a temporal sequence of left and right images, such as that in a video or movie. The sequence of modified images may be shorter than one second to minimise viewer's awareness of the manipulation. The magnitude of the first and second defined values for each left/right image pair may vary during the sequence. For example, the magnitude of the first and second defined values may diminish during the sequence. This may facilitate attracting the viewer's attention initially by using a large defined value but also reduce viewer awareness by a reduction of this value over time. In one embodiment, the magnitudes of the first and second defined values may increase to a specified threshold during the initial image frames of the sequence, and the magnitudes of the first and second defined values may diminish from the specified threshold during some subsequent frames of the sequence. In one embodiment, the size of the portions may vary as well as, or instead of, the magnitude variation. For example, the size of the portions may diminish during the sequence.

The images may be digital images.

According to another aspect of the invention there is provided a system for modifying a left image destined for the left eye and a right image destined for the right eye, including:

an image modification means for modifying a portion of the left image by adjusting a visual characteristic of the portion in a first direction by a first defined value and for modifying a corresponding portion of the right image by adjusting the visual characteristic of the corresponding portion in the opposite of the first direction by a second defined value.

The system may include a storage means configured to store the unmodified images and/or the modified images. The storage means may be a digital memory such as RAM, a hard-drive, or a digital tape, or it may be an analogue memory such as film stock.

The image modification means may be a processor or a filter. The image modification means may be a processing unit embedded within a television such as a 3D television; an optical disc player, such as a 3D blu-ray player; a 3D camera; or may be active or passive filters placed within viewer's glasses or over camera lenses, graphics or film editing software or hardware, or 2D to 3D conversion software or hardware.

The image modification means may be adapted to perform any of the features of the method of the first aspect.

According to another aspect of the invention there is provided an apparatus, including:

an image display means for displaying a left image destined for a left eye and a right image destined for a right eye, wherein a portion of the left image has been modified by adjusting a visual characteristic of the portion in a first direction by a first defined value and a corresponding portion of the right image has been modified by adjusting the visual characteristic of the corresponding portion in the opposite of the first direction by a second defined value.

The image display means may be a television, a projector, a visual display embedded within viewer glasses, a combination of a display and active/passive 3D glasses, a filter system for glasses, or any other means of displaying images to the left and right eyes of one or more viewers.

According to another aspect of the invention there is provided a signal comprising data corresponding to a left image destined for a left eye and a right image destined for a right eye modified by the method of the first aspect.

The signal may be transmitted over a broadcast network, a multi-cast network, a uni-cast network, an intra/inter-network, or any other one-way or two-way communications system.

According to another aspect of the invention there is provided a medium configured to store data corresponding to a left image destined for a left eye and a right image destined for a right eye modified by the method of the first aspect.

The medium may be an optical disc, such as a DVD or Blu-ray disc, a solid state memory, such as flash memory, or any other medium.

According to another aspect of the invention there is provided a computer program configured to implement the method of the first aspect.

According to another aspect of the invention there is provided a method of modifying a left-right image pair such that at least one visual characteristic of a portion of both images differ, preferably, in ways beyond that can be produced by direct image capture or formation from visual scenes.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a system in accordance with an embodiment of the invention;

FIG. 2a: shows a diagram illustrating the modification of the contrast of portions of a left-right image pair in accordance with an embodiment of the invention;

FIG. 2b: shows a diagram illustrating the modification of the luminance of portions of a left-right image pair in accordance with an embodiment of the invention;

FIG. 3: shows a method in accordance with an embodiment of the invention;

FIG. 4a: shows a diagram illustrating the boundaries surrounding portions of a left-right image pair in accordance with an embodiment of the invention;

FIG. 4b: shows a diagram illustrating multiple portions forming a larger portion of a left-right image in accordance within an embodiment of the invention;

FIG. 5: shows a left-right image pair modified in accordance with an embodiment of the invention;

FIG. 6: shows a sequence of left-right image pairs modified in accordance with an embodiment of the invention;

FIG. 7: shows a sequence of left-right image pairs modified in accordance with an embodiment of the invention;

FIG. 8: shows an apparatus for viewing images modified in accordance with an embodiment of the invention; and

FIG. 9: shows experimental results obtained by using an embodiment of the invention.

### DETAILED DESCRIPTION OF PREFERRED EMBODIMENTS

The present invention provides a method and system for modifying binocular images, for example, to manipulate a viewer's attention.

The inventor has discovered that if the visual characteristics of a portion of an image viewed by the left eye and that of the corresponding portion of an image viewed by the right eye differ substantially, (whereas outside these image portions the visual characteristics at the binocular corresponding locations do not differ substantially between the two eyes,) a human viewer's attention is drawn to the portion.

This discovery was surprising because it has been known in the research community that the differences between the (visual characteristic in the) two eyes are not consciously perceived. The discovery is counter-intuitive since it dissociates human awareness of some binocular input properties (in this case, the binocular difference in inputs) from human attentional shifts by the same binocular input properties.

It also transpires that the viewer, when combining the two images in the brain, perceives that portion as roughly an average of both the left and right portions. For example, if a ball in an image for the left eye is darkened and the ball in the image for the right eye is lightened, the viewer's attention is drawn to the ball, but the ball is perceived roughly as an average of the darkened ball and lightened ball.

The inventor has developed a method and system for modifying a left image destined for the left eye and a right image destined for the right eye by modifying the visual characteristics of the portions of both images such that when the images are perceived the viewer is not conscious that the portions have been modified, but the viewer's attention is drawn to the modified portions.

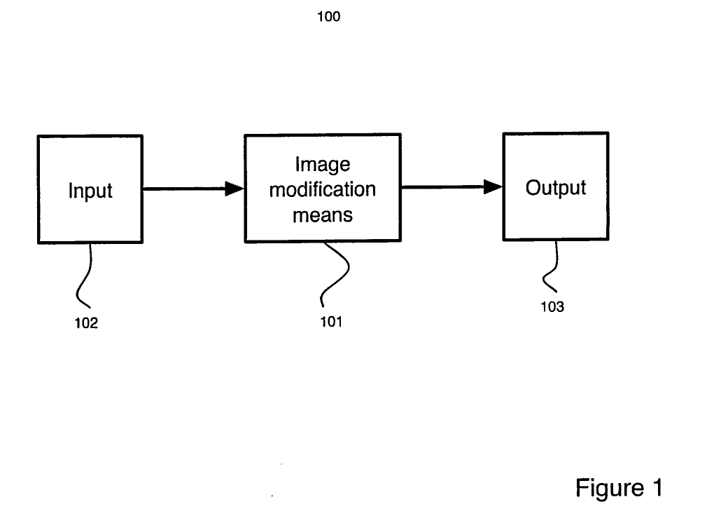

In FIG. 1, a system 100 for modifying binocular images in accordance with the invention is shown.

An image modification means 101 is shown. The image modification means 101 may be a processor, such as a computer processor, or a specialised processor to be used within a camera, video camera, optical disc player, or television.

Where the image modification means 101 is within a device controlling the display of modified images, such as within a television, optical disc player, or computer, the image modification means 101 may include the ability to switch off or on the image modifications, or to adjust the magnitudes of the modifications. The magnitude adjustment may be calibrated specifically to a device or to a particular viewer.

In one embodiment, the image modification means 101 is a filter. The filter may be a passive filter, such as a filter for placement over the lens of a still or video camera, or the filter may be an active filter, for example, an electronically controlled variable luminance filter.

An input 102 is shown. The input 102 may produce a left-right image pair. Each image may be a digital image or it may be an analogue image. The image may be projected or displayed, or it may be light generated from a real physical environment.

An output 103 is shown. The output 103 is a left-right image pair. The image may be a digital image or an analogue image.

The input 102 and output 103 are connected to the input modification means 101.

The image modification means 101 may be configured to receive an image or images from the input 102, to modify a left image destined for a viewer's left eye by adjusting a visual characteristic of a portion in one direction by a defined value, and to modify a right image destined for a viewer's right eye by adjusting the visual characteristic of a corresponding portion of the right image in the opposite direction by a defined value.

The visual characteristic may be contrast, luminance, or colour.

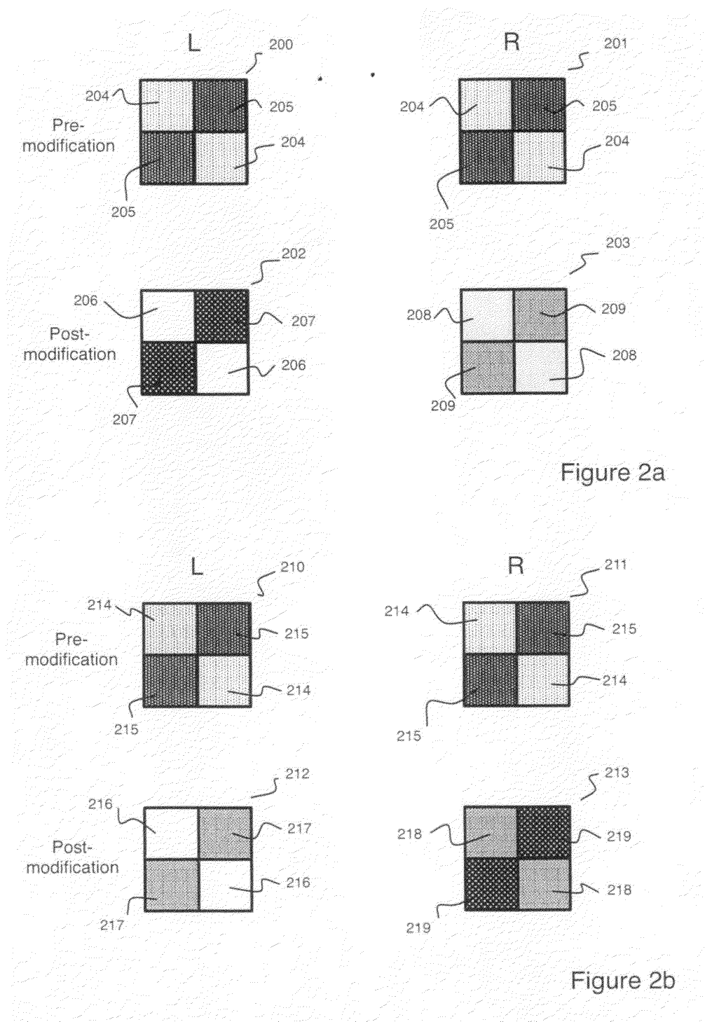

For example, where the visual characteristic is contrast, the image modification means 101 may adjust a portion of the left image by increasing the contrast in that portion and may adjust the corresponding portion of the right image by decreasing the contrast of the corresponding portion. An example is shown in FIG. 2a. 200 is a portion of the left image, and 201 is a portion of the right image. 202 and 203 are the respective modified portions. 204 are pixels of luminance one hundred, 205 are pixels of luminance fifty. After modification, the 204 pixels of portion 200 have been changed to 206 pixels of luminance one hundred and fifteen, the 205 pixels of portion 200 have been changed to 207 pixels of luminance thirty-five, the 204 pixels of portion 201 have been changed to 208 pixels of luminance eighty-five, and the 205 pixels of portion 201 have been changed to 209 pixels of luminance sixty-five. It can be seen that the contrast of portion 200 has been increased in modified portion 202 and the contrast of portion 201 has been decreased in modified portion 203.

Where the visual characteristic is luminance, the image modification means may adjust a portion of the left image by brightening the portion and may adjust a corresponding portion of the right image by darkening the portion. An example is shown in FIG. 2b. 210 is a portion of the left image, and 211 is a portion of the right image. 212 and 213 are the modified portions. 214 are pixels of luminance one hundred, 215 are pixels of luminance fifty. After modification, the 214 pixels of portion 210 have been changed to 216 pixels of luminance one hundred and twenty, the 215 pixels of portion 210 have been changed to 217 pixels of luminance sixty, the 214 pixels of portion 211 have been changed to 218 pixels of luminance eighty, and the 215 pixels of portion 211 have been changed to 219 pixels of luminance forty. It can be seen that the luminance of portion 210 has been increased in modified portion 212 and the luminance of portion 211 has been decreased in modified portion 213.

Where the visual characteristic is colour, the adjustments may be to adjust the left image portion in a colour-space in one direction and to adjust the right image portion in the colour-space in roughly the opposite direction.

Portions may “correspond” where they relate to the same feature (in a 2D or 3D scene). The feature may be a physical object, a Computer Generated Imagery (CGI) effect, or a design element. In one embodiment, the feature is not necessarily exactly delineated by the portion, and/or the correspondence of the portions is not necessarily exact.

The left-right image pair may evoke a perception of a 3D scene when viewed dichoptically. Such a 3D scene may be from a 3D film, a 3D television programme, a 3D advertisement, a 3D-enabled game, or a 3D photo/image.

Where the image modification means is a processor, the processor may be configured to receive each image; identify a portion within each image, for example, by identifying pixels of each image for modification; to modify each image by adjusting the contrast/luminance/colour values of each pixel of the left portion in a first direction and the contrast/luminance/colour values of each pixel of the right portion in the opposite direction; and to output the modified images.

Where the image modification means is a filter, the filter may be configured to modify each portion by adjusting the contrast/luminance/colour of the image by filtering the portion, for example, by contrast enhancing/reduction, brightening/darkening, or moving within the colour-space. The filter may be fixed or dynamic. Where the image modification means is a filter equipped with the image processing ability. The image processor may be configured to modify each portion by adjusting the contrast/luminance/colour of the image, for example, by contrast enhancing/reduction, brightening/darkening, or moving within the colour-space. The outcome of this image processing is used to control the filter such that the inputs to the filter are the images before the modification and the outputs from the filter are the images after the modification. For example, the filter may be controlled by the image processor such that it allows the transmission of each input image pixel by a degree according to whether this image pixel signal should be enhanced or reduced to become an corresponding output pixel signal. And the filter outputs may be viewed directly or displayed to the viewers.

The processor may identify the portion by a predefined set of signals or the processor may utilise heuristics or other logic to identify portions. The predefined set of signals may be embedded within the input or associated with the input.

The predefined signals may be generated by image/video editors utilising image/video softwares to select the left and/or right image portions.

The system may include a storage means connected to the output. The storage means may be temporary memory such as RAM, persistent memory such as Flash memory or a hard drive, or an analogue film tape.

In one embodiment, the system includes a transmission means, such as a telecommunications system, broadcast system, internet system, or LAN, connected to the output, and the modified images are transmitted to one or more viewers of the images via, at least, the transmission means.

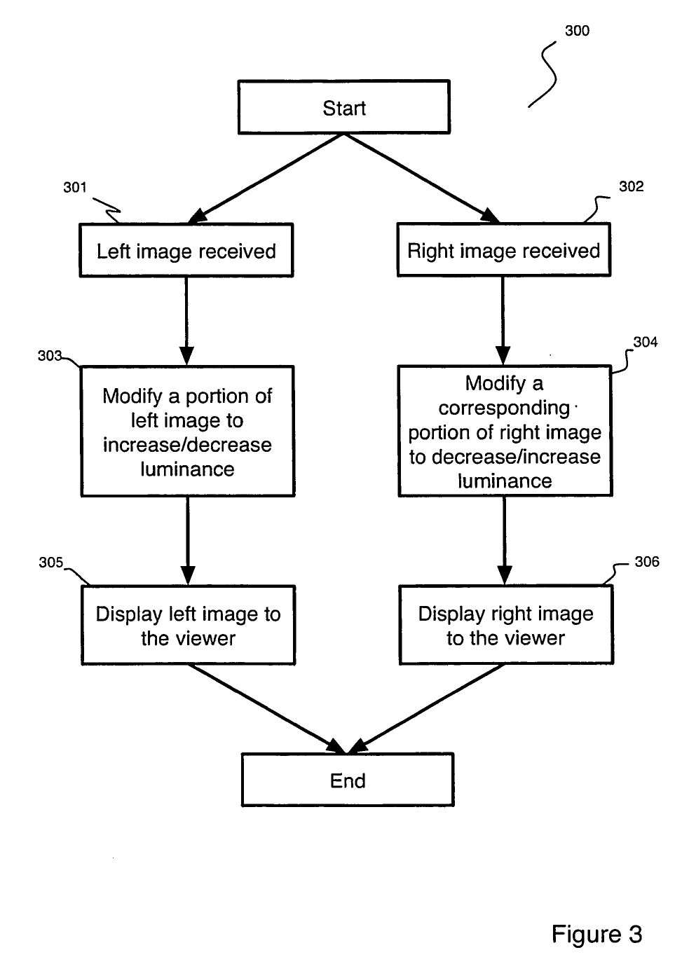

In FIG. 3, a method 300 for modifying binocular images in accordance with the invention is shown.

In step 301, a left image may be received. The left image may be received from the storage means, such as an optical disc or flash memory, a transmission, such as broadcast or over the Internet, from a real environment, from a processing block, or from a camera.

In step 302, a right image may be received. The right image may be received from the storage means, such as an optical disc or flash memory, a transmission, such as broadcast or over the Internet, from a real environment, from a processing block, or from a camera.

The left and right images may be received simultaneously or consecutively.

In step 303, the portion of the left image is modified by adjusting the visual characteristic in a first direction by a first defined value. The portion may be modified by the image modification means.

In step 304, the corresponding portion of the right image is modified by adjusting the visual characteristic in an opposite direction by a second defined value. The portion may be modified by the image modification means.

In step 305, the modified left image may be displayed to the left eye of a viewer.

In step 306, the modified right image may be displayed to the right eye of the viewer.

The magnitudes of the defined values may be below a first determined threshold. The threshold may be determined based upon the type of visual characteristic, the size of the portions, and the spatial variations and temporal dynamics of the modifications, and the visual sensitivities of the viewers.

In some results it has been discovered that magnitudes such that the modified visual characteristics of the two portions do not differ by a factor of more than 6 may form a useful maximum for the first determined threshold.

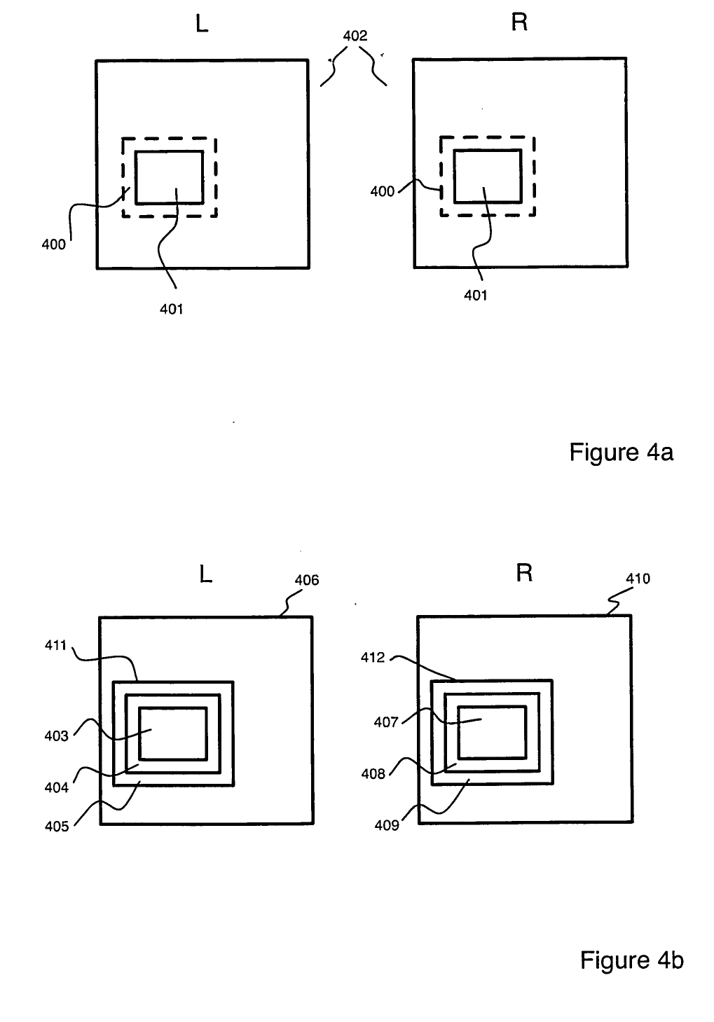

The difference between the two portions may be calculated with reference to the area outside of the portions which may be all the area or to a boundary surrounding the portions. The boundary may be determined as described in relation to FIG. 4a.

For example, if the portions have a pre-modified average luminance value of 50 and the area/boundary (the background) has an average luminance value of 100. Then to modify the portion of the left image to 85 and the portion of the right image to 25 will result in a factor difference of 7.4 as shown below:

The contrast of the left portion in relation to the background is:

c(left)=(100−85)/(100+85)=15/185=3/37

The contrast of the right portion in relation to the background is:

c(right)=(100−25)/(100+25)=3/5

The difference between the left and right portions is:

c(right)/c(left)=3/5×37/3=7.4

The defined values may be similar. The defined values may be within a second determined threshold from each other.

The second determined threshold may be calculated or adjusted dependent upon one or more of the following factors: whether viewers are to be aware of the manipulation or not, the sensitivity of individual viewers, overall visual characteristics of the left-right image pair, and to what extent adjacent image-pairs in a sequence have been manipulated.

The second determined threshold may be calculated from a percentage of the difference between the visual characteristics of the portion and its boundary. The width of the boundary may be dependent on the visibility of the boundary to a normal or a targeted viewer and on the size of the attentional window of the viewer. FIG. 4a illustrates the boundary 400 surrounding a portion 401 in a left-right image pair 402.

In some results it has been discovered that 10% is a useful maximum for the percentage of the difference, so that the viewers do not become aware of or disturbed by the image modifications.

For example, when the average luminance of portions in the original image is 100 (in both images) in a gray scale between 0 and 255 against a background of 0 gray levels, then the luminance change in the left image and the luminance change in the right image should not differ by more than 10. So for example, the luminance may be increased in the left image by 50 (i.e., change luminance from 100 to 150) and decrease the luminance in the right image by 60 (i.e., change luminance from 100 to 40), in this case, the average luminance in the two eyes before the change is 100, and after the change the average luminance is 95, the average luminance changes only by 5% (less than 10%), the viewers are not so aware of such changes which make the average luminance change by no more than 10%.

In one embodiment, the modified images are transmitted for display or projection, and viewers view each displayed or projected image through active or passive 3D glasses.

In one embodiment, the left and right images are first processed to identify the portions for modification. The portions may be identified by an automated processing method, such as an artificial intelligence engine for identifying features, by a human processing method, such as outlining a feature using a GUI within a software programme, or a combination of both methods, such as a human selecting a feature within one image and an automated processing method performing edge/feature detection to select the feature as the portion and/or selecting the corresponding feature within the other image.

In one embodiment of the invention, shown in FIG. 4b, there is a plurality of portions 403, 404, and 405 of the left image 406, each with a specific first defined value, and a plurality of corresponding portions 407, 408, and 409 of the right image 410, each with a specific second defined value. Each of the plurality of portions 403, 403, and 405 and 407, 408, and 409 forms a contiguous larger portion 411 and 412 respectively. The larger portions 411 and 412 may represent a specific feature within the images. The defined values of each plurality of portions 403, 403, and 405 and 407, 408, and 409 may be configured such that the values change in magnitude from the centre 403 and 407 of the larger portion 411 and 412 out to its outer edges 405 and 409. This may provide a different effect in attracting the attention of the viewer.

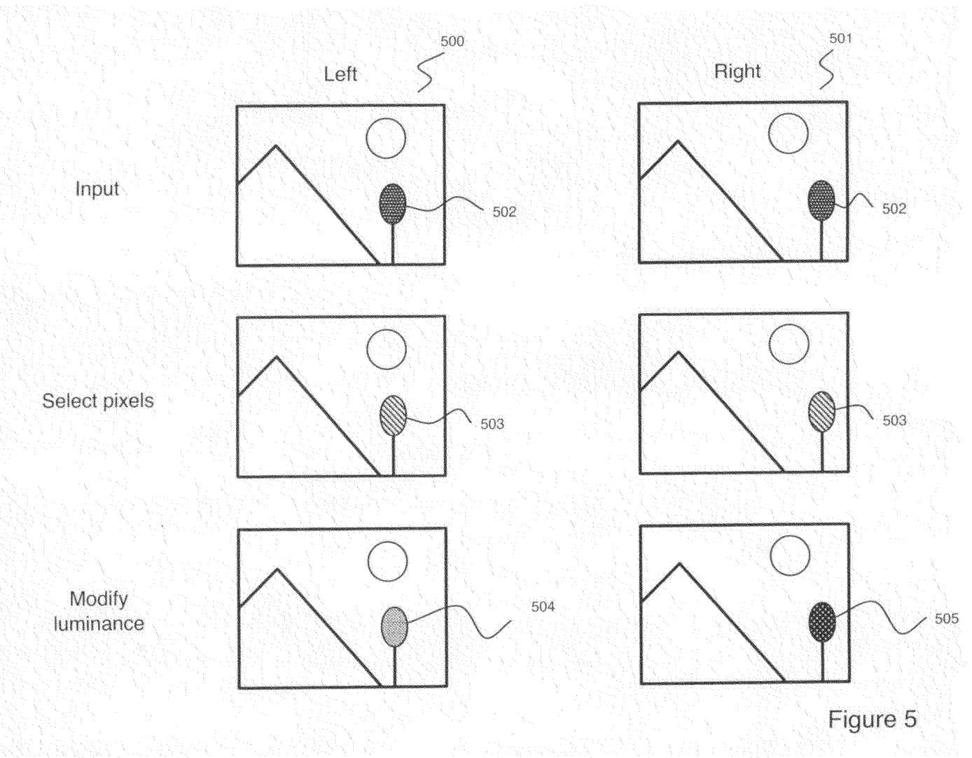

An embodiment of the invention will now be described with reference to FIG. 5.

A static 3D display comprises a pair of images 500 and 501, one viewed by the left eye and one viewed by the right eye.

To attract the viewer's attention to a particular object 502 within the 3D display, the image pixels of the object are first identified 503. The luminance of these pixels in the left and right eye images is typically comparable.

To make this object attract attention in a 3D display, the luminances (or image contrast) of the pixels are modified using any image processing tool. The pixel luminance (or image contrast) is turned up in the left-eye pixels 504 and down in the corresponding right-eye pixels 505 by the same (or similar) amount, or equivalently, the pixel luminance (or image contrast) is turned down in the left-eye pixels and up in the right-eye pixels by the same (or similar) amount.

Where the net change of luminance (or image contrast) summed over two eyes is zero, observers are less likely to be aware of the manipulation while being manipulated. When the net change does not sum to zero, the observers will be more likely to be aware of the manipulation. The amount of this non-zero net change needed for awareness is, e.g., for luminance change, approximately 10% (the percentage may vary somewhat depending on the size of the portion and the temporal dynamics of the visual inputs) of the luminance of the changed image area relative to the luminance of background area.

Therefore, the image manipulation has two components: one is the amplitude of the pixel luminance (contrast) changes, and the other is the direction of luminance (contrast) changes—whether it is up in the left eye and down in the right eye, or the other way around. As the luminance (contrast) changes in the left-eye pixels and right eye pixels have the same amplitude, but are in opposite directions, the inventor has determined that they cause little change in the perception of the viewer, since the summed luminance (contrast) entering the two eyes from this object is unchanged. However, the inventor has determined that this image manipulation will enhance the degree in which this object attracts viewer's attention. The degree of enhanced attraction increases with the amplitude of this luminance (contrast) manipulation, as long as this amplitude is not too high (effectiveness may be affected when the pixel signals luminance/contrast for the object in the two eyes differ by a factor of 6 or more). It is not essential or necessary that all image pixels for the intended object are targeted for the manipulation. For example, it is like somebody is pointing out something (e.g., a person in a street) to you, and it is not necessary for this person to point to all locations of this object (e.g., to the eyes and nose and face and shoulders) to direct your attention. The system will produce successful results if only a small patch of image pixels belonging to the intended object are targeted and the patches in the two images roughly correspond. To avoid possible undesirable artefacts, it is preferred that the boundary of this image patch follows natural object surface boundaries. For example, if the intended object is a human face, the effect is successful if the image patch for one eye only is modified, but it is preferred to make this patch coincide with the image area for the whole eye or for the whole contour line of the upper eye lid.

Depending on the desired effect, an image editor can change the extent of the image manipulation by changing the size of the image patch and the amplitudes of the luminance (contrast) changes.

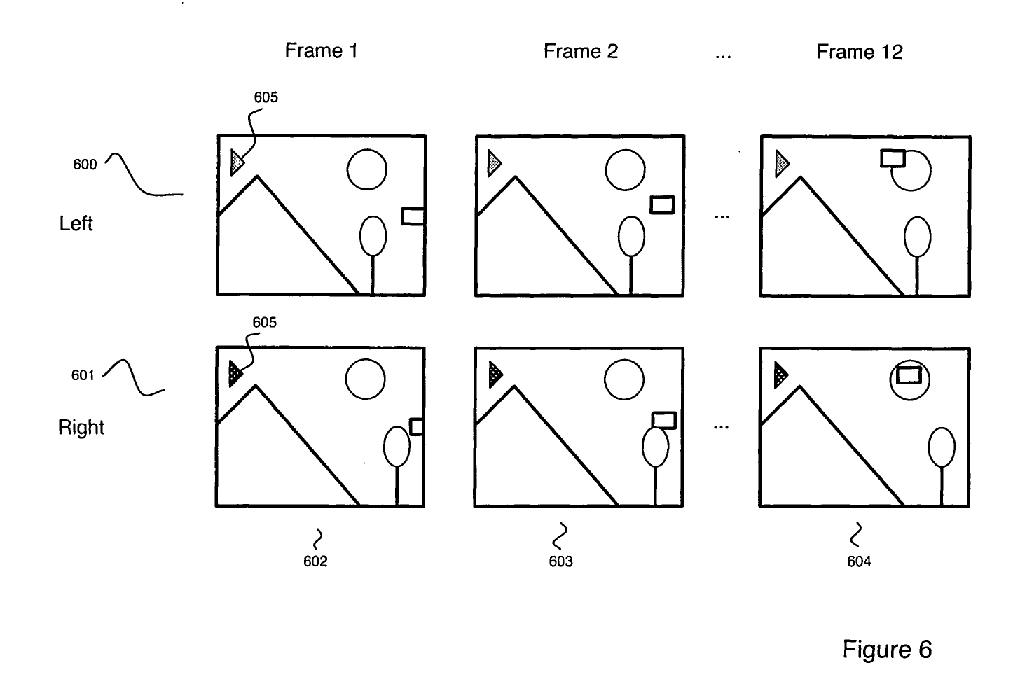

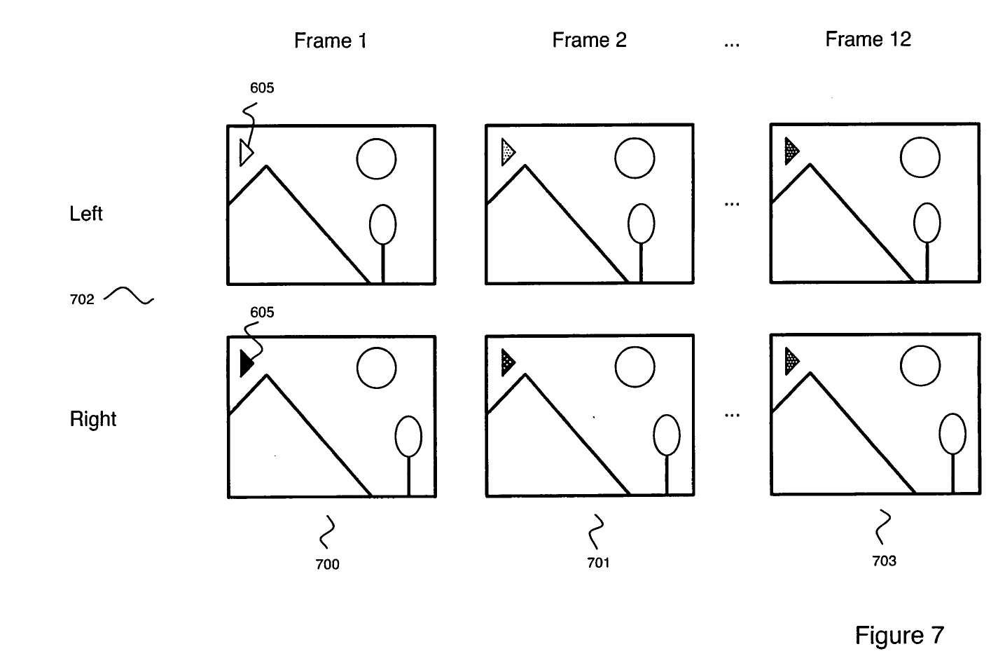

A further embodiment of the invention will now be described with reference to FIGS. 6 and 7.

In a 3D movie or video, there is a pair of temporal sequences of images, one sequence 600 for the left eye and another 601 for the right eye. The left-right image pairs 602, 603 and 604 are identified in these sequences for the time moments in the movie where it is desired for an object 605 to attract attention. Image modification is performed for each pair in the same way as in static 3D displays, except that the direction of the luminance manipulation, i.e., whether the luminance in the left or right eye image is turned up, should be the same in consecutive image pairs.

In order to attract the attention of the viewer, manipulation will typically only be necessary between a dozen and several dozen temporally consecutive image pairs in a movie sequence, corresponding to a temporal duration of a fraction of a second to a second or so. This is comparable to the duration of somebody pointing out to you something interesting in a movie: once your attention is directed to that object, there is no need for the pointing to continue.

Again, depending on the desired effect, the movie editor can adjust the extent and the dynamics of the image manipulations: (1) the amplitudes of the luminance changes in image pairs, (2) the sizes of the image patches manipulated, and (3) the number of consecutive image pairs in the image sequences to manipulate.

Additionally, the extent of the image manipulations, e.g., the amplitudes of the luminance manipulations and/or the sizes of the manipulated image patches, could change in consecutive image pairs 700, 701 in a movie sequence 702. For example, this extent could be large in the first image pair 700 in the sequence 702 and gradually tapers off in the subsequent image pairs 701 and 703 for a desired time duration in the movie. The movie editor can adjust this according to desired effect on attentional guidance and on whether to prevent or enable the awareness of the viewers of this guidance. For example, some manipulations may have a large amplitude but are temporally brief, and others may have a small amplitude, and thus a subtler pull on attention, but are temporally longer lasting. Additionally, the amplitude of the luminance/contrast change may be different for different pixels in the selected image portion, e.g., this amplitude can be high in the centre of the selected image portions and smoothly reduced towards the periphery of the portions.

In one embodiment, only one object is targeted for attracting attention at any time instant, just like a person should only point one thing at a time to guide your attention effectively. This may provide the advantage of an improved effect. This advantage may be retained when different objects are targeted in different (e.g., consecutive or partly overlapping) temporal durations.

In one embodiment, image-pairs are modified such that the ocular imbalance for the intended object to attract attention is sufficiently different from that of the background scene. Here, ocular imbalance or ocularity signal is defined as the percentage difference between the pixel luminance (contrast) in the left-eye image and the corresponding pixel luminance (contrast) in the right eye image for the same object. In an alternative embodiment, an object can be made to attract attention if the image pixels for the intended object are ocularly balanced while those for the background scene have a uniform or near-uniform ocular imbalance. However, such an ocularity arrangement may cause discomfort in some sensitive viewers.

In one embodiment, where the image pixels for an object are overly ocularly imbalanced (for example, where the contrast in the left and right images differ by a factor of 10 or more) against an ocularly balanced background this may cause repulsion of attention which may also prove useful in certain applications.

In one embodiment, areas of the image-pairs surrounding the portion (or object) are also modified to a lesser extent in dependence on the distance from these pixels to the edge of the portions. In other words, a feathering surrounding the portion/object.

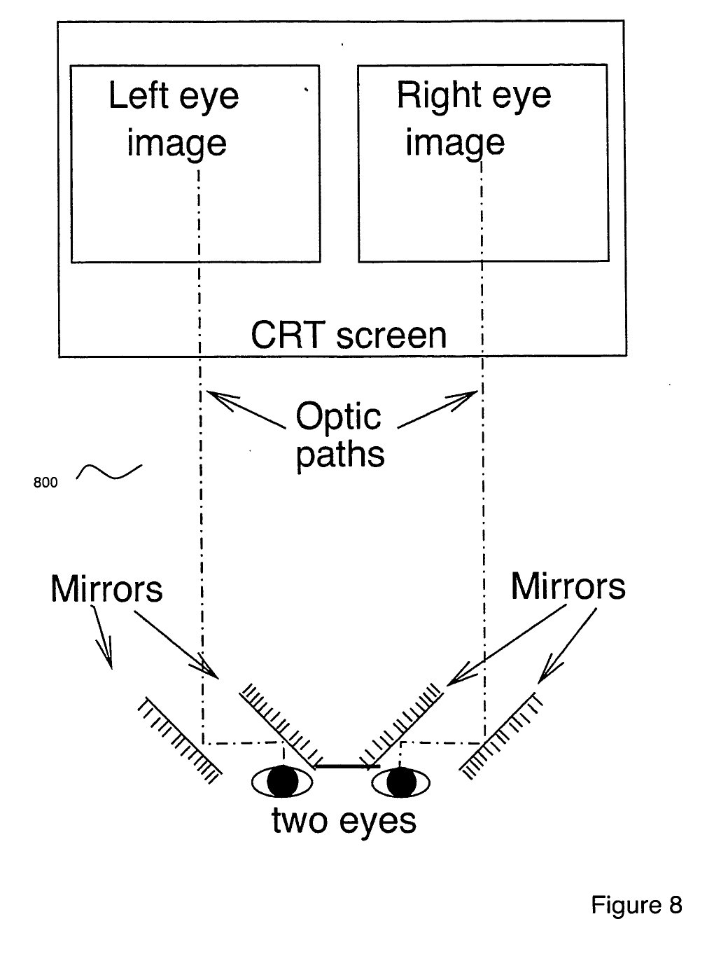

FIG. 8 shows an exemplary apparatus 800 for displaying binocular images to a viewer.

The apparatus 800 shown is a mirror stereoscope, and images intended for the left and right eyes are displayed on the left and right half of a CRT screen. The mirrors enable that the respective eye view each half of the screen.

Another exemplary apparatus for displaying binocular images to a viewer, not shown, is by 3D shutter glasses, with images presented on a Clinton Monoray monitor, at a frame rate of 150 Hz. The images are viewed with FE-1 shutter goggles from Cambridge Research Systems. The shutter goggles, with 25% open shutter transmission, 100 μs shutter open-close switching time, and a 500:1 ratio for open:close transmission, let left and right eyes view the temporally alternate frames on the screen, so that each eye views 75 out of the 150 frames each second without any sensation of flicker.

It will be appreciated by those skilled in the art that any apparatus can be used which enable viewers to see 3D or binocular images, as long as the images or image sequences intended for the two different eyes of the viewers are somehow delivered to the two different eyes. For example, by 3D shutter glasses (which let two eyes see alternating frames on a screen), polarized glasses (letting different eyes see different images shown in differently polarized light), anaglyph glasses (to let left and right eyes see two differently colored images), stereoscopes which use mirrors to direct different display screens to the different eyes, or by directed light rays aimed for the two different eyes. Any other techniques that can effectively deliver the respective images to the respective eyes can also be used.

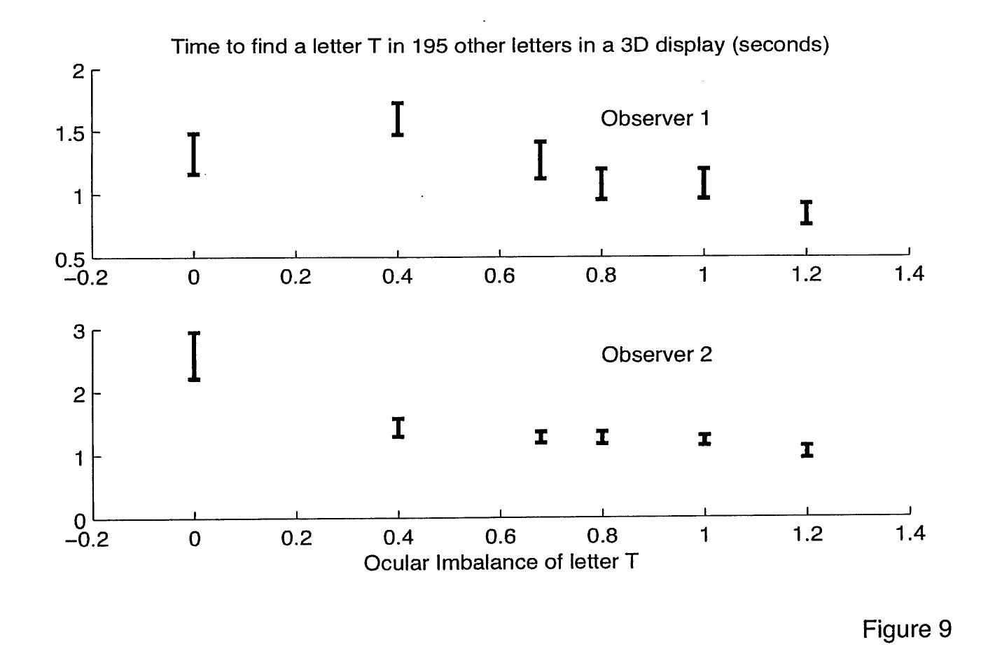

Using the viewing apparatus 800 described in FIG. 8, the inventor performed an experimental test using image-pairs generated by an embodiment of the invention. FIG. 9 shows the experimental results for two observers obtained from the test.

Observers were asked to look for a letter T among 195 other letters floating in a 3D space in a 3D display. The time for observers to find the letter decreased with the amplitude of the ocular imbalance of the letter T (all other letters are ocularly balanced). Here, ocular imbalance of a letter is defined as the ratio between the ocular difference and the ocular average (of the image pixel luminances associated with the letter). Hence, if the ocular imbalance is zero, the images are not manipulated, and increasing ocular imbalance of letter T shortened the time needed for observers to find it. This effect was stronger in observer 2 who is initially slower than observer 1. Therefore, attentional guidance provided by the modification of the image-pairs by an embodiment of the invention reduced the time needed to find T, from more than 2 seconds to about 1 second. This is considerable considering that human beings shift their gaze 3 times a second.

In another test, not shown, observers attempted to determine whether a letter T or a letter X is among the 195 other letters in a 3D scene briefly displayed for only one second. The observers are forced to guess if they did not find either letter in such a brief duration. Again, increasing ocular imbalance of the target letters reduced observers' performance errors.

Embodiments of the invention may be used for the following applications:

3D advertisements: whether in static 3D image displays or 3D movies and Ns, the modification method of the invention may be used to direct viewers' attention to advertised products. This may be particularly useful in short movie or TV advertisements, in which the broadcast/projection cost of each second of the advertisement clip is high. Traditional time-consuming techniques for attracting/forcing viewer's attention, such as zooming of the camera to or making an actor direct their gaze to the intended object, can be supplemented or replaced. The method of the invention may be favourable since the viewers may be unaware that their attention is being manipulated.

3D films and TV programmes: an embodiment of the invention may be used to direct attention or even distract attention to enhance viewers' comprehension of the narratives to achieve any artistic intent of the film/TV directors. This may be particularly advantageous for fast dynamic scenes in which effective and fast shifts of attention and gaze of the viewers are essential to following the narrative. A potential further advantage is that as the method of the invention can guide attention with little noticeable change to the perception, it does not affect the original artistic intention of the film/TV programme.

3D TV programmes/films for sports (or popular) events: as for 3D film/TV, an embodiment of the invention can be used to direct attention to important locations in crowded and fast moving scenes, e.g., directing attention to a soccer ball, or to a pop singer in a busy crowd. The selection of these features can be performed by image processors employed with human-computer interface (HCI) between the sport/event commentator and the image processors.

3D computer games: game players can achieve better game performance when their attention is directed at the right places at the right times, and quickly. An embodiment of the invention may be used in 3D game development for this purpose or to train game players. Furthermore, the games can be developed such that this manipulation could be enabled or disabled by turning on or off an option in the game play, giving more options of experience to the players.

3D educational/learning/training tools: many learning software for school children or adults alike could be developed in 3D. Guiding learners' attention can be useful in these learning or training tools. The targeted learners could be children with attentional deficits (e.g., ADHD), or adults who can benefit with some attentional guidance in learning. Embodiments of the invention may be used to provide non-intrusive attentional guidance, enabling the learners to be immersed with minimum intervention by helpers.

3D medical therapy tools: doctors can be assisted by attentional guidance in 3D displays using an embodiment of the invention. In alternative embodiments, patients' attention could also be guided. For example, attentional guidance could be potentially used to capture the attention of depressed patients towards cheerful images (as these patients tend to avoid looking at cheerful scenes).

2D to 3D film/DVD conversion: 2D/3D conversion software converts 2D movies and DVDs to 3D. Embodiments of the invention can be integrated within such software to add additional editing control over 3D versions of 2D films.

3D still or film cameras and camcorders: an embodiment of the invention can be directly built into a 3D still or film cameras and camcorders. This embodiment may facilitate the camera user pre-selecting the object/feature they wish to focus the camera on, the camera can have the option to apply the modification method of the invention to modify the user selected object/feature to make it attract attention in the film outputs. This feature may operate in conjunction with normal focusing systems or it may operate independently of normal focussing systems, for example, to visually focus on one object but redirect the viewer's attention elsewhere using the modification method.

3D photos/images: an embodiment of the invention can be used to modify the left-right image pairs for 3D photos/images.

2D image viewing augmentation: where a viewer has a 2D display, embodiments of the invention could be used to direct the viewer's attention to portions of the 2D display that might require their immediate attention. To enable this, the viewer may wear glasses which display different images to the left and right eye of the 2D display. For example, a stock trading screen may display numerous information, it may be desirable for a viewer to focus on a particular portion of the screen when an important event has occurred. The viewer may have become inured against visual indicators that can be consciously ignored. Embodiments of the invention may be able to attract the viewer's attention to the particular portion without their awareness and, thus, without them being able to consciously ignore the modification. It will be appreciated that this may be of relevance for many systems, such as flight control monitoring systems.

Augmented reality: embodiments of the invention can be used to augment the vision of users. For example, the user may wear a headset with one camera for each eye, the user views the real world directly but a processor analyses images from the two cameras to control a filter for glasses worn by the user such that the user's view through the glasses is modified. The filter increases the luminance/contrast of portion of one lens and decreases the luminance/contrast in the corresponding portion of the other lens to direct the user's attention.

It will be appreciated that the present invention may be implemented as software executing on computer hardware or within hardware itself.

A potential advantage of some embodiments of the present invention is that the attention of a viewer to a particular portion of a viewed image may be obtained without modifying the perceived visual appearance of the display.

A further potential advantage of some embodiments of the present invention is that because the attention of a viewer to a particular portion of a viewed image may be obtained without modifying the perceived visual appearance of the display, the viewer may not be aware of being manipulated and may not be able to consciously ignore the particular portion.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method of modifying a left image destined for a left eye and a right image destined for a right eye, including:
i) modifying a portion of the left image by adjusting a visual characteristic of the portion in a first direction by a first defined value; and
ii) modifying a corresponding portion of the right image by adjusting the visual characteristic of the corresponding portion in the opposite of the first direction by a second defined value.

2. A method as claimed in claim 1 wherein the first and second defined values are similar in magnitude.

3. A method as claimed in claim 1 wherein the visual characteristic is one or a combination selected from the set of contrast, luminance and colour.

4. A method as claimed in claim 1 wherein the portions of the left and right images relate to the same feature.

5. A method as claimed in claim 4 wherein the portions of the left and right image relate to a visual feature within a 3D or 2D scene.

6. A method as claimed in claim 1 wherein the left and right images evoke a perception of a 3D or 2D scene when viewed dichoptically.

7. A method as claimed in claim 1 wherein steps (i) and (ii) are repeated for a sequence of left and right images.

8. A method as claimed in claim 7 wherein the magnitude of the first and second defined values diminishes during the sequence.

9. A method as claimed in claim 1 wherein a plurality of portions for the left image are modified and a plurality of corresponding portions for right image are modified, each plurality of portions forming a larger contiguous portion and wherein at least some of the defined values differ from one another for each plurality of portions.

10. A method as claimed in claim 1 wherein the portions of the left and right image cover the entire respective image except for a specific feature.

11. A system for modifying a left image destined for the left eye and a right image destined for the right eye, including:
an image modification means for modifying a portion of the left image by adjusting a visual characteristic of the portion in a first direction by a first defined value and for modifying a corresponding portion of the right image by adjusting the visual characteristic of the portion in the opposite of the first direction by a second defined value.

12. A system as claimed in claim 11 wherein the first and second defined values are similar in magnitude.

13. A system as claimed in claim 11 wherein the visual characteristic is one or a combination selected from the set of contrast, luminance and colour.

14. A system as claimed in claim 11 wherein the portions of the left and right images relate to the same feature.

15. A system as claimed in claim 14 wherein the portions of the left and right image relate to a visual feature within a 3D or 2D scene.

16. A system as claimed in claim 11 wherein the left and right images evoke a perception of a 3D or 2D scene when viewed dichoptically.

17. A system as claimed in claim 11 wherein the image modification means is further configured to modify a temporal sequence of left and right images by modifying a portion of each left image by adjusting a visual characteristic of the portion in a first direction by a first defined value and to modify a corresponding portion of each corresponding right image by adjusting the visual characteristic of the portion in the opposite of the first direction by a second defined value.

18. A system as claimed in claim 17 wherein the magnitude of the first and second defined values diminishes during the sequence.

19. An apparatus, including:
an image display means for displaying a left image destined for a left eye and a right image destined for a right eye, wherein a portion of the left image has been modified by adjusting a visual characteristic of the portion in a first direction by a first defined value and a corresponding portion of the right image has been modified by adjusting the visual characteristic of the corresponding portion in the opposite of the first direction by a second defined value.

20. A signal comprising data corresponding to a left image destined for a left eye and a right image destined for a right eye modified by the method of claim 1.

21. A medium configured to store data corresponding to a left image destined for a left eye and a right image destined for a right eye modified by the method of claim 1.

22. A computer program configured to implement the method of claim 1.
